(19) United States
(12) Patent Application Publication
(10) Pub. No.: US 2018/0034788 A1
(43) Pub. Date: Feb. 1, 2018

(54) COOPERATION MANAGEMENT APPARATUS AND COMMUNICATION SYSTEM

(71) Applicant: FUJI XEROX CO., LTD., Tokyo (JP)

(72) Inventor: Yasuyuki HIGUCHI, Kanagawa (JP)

(73) Assignee: FUJI XEROX CO., LTD., Tokyo (JP)

(21) Appl. No.: 15/490,331

(22) Filed: Apr. 18, 2017

(30) Foreign Application Priority Data
Jul. 27, 2016 (JP) 2016-147185

(51) Int. Cl. H04L 29/06; H04L 9/08; G06F 21/60; H04L 9/14

(52) U.S. Cl. CPC H04L 63/0464; H04L 9/14; H04L 9/0894; G06F 21/602; H04L 2209/12; G06F 2221/2107

(57) ABSTRACT

A cooperation management apparatus includes:
a key storage unit that stores
   a first decryption key corresponding to a first encryption key commonly used by plural information processing systems including first and second information processing systems, and
   plural second encryption keys corresponding to second decryption keys individually used by the information processing systems;
an acquisition unit that acquires, from the first information processing system, a first file encrypted using the first encryption key and addressed to the second information processing system;
a decryption unit that decrypts the first file into a second file using the first decryption key;
an encryption unit that encrypts the second file using the second encryption key corresponding to the second decryption key used in the second information processing system; and
an output unit that outputs a third file obtained by encrypting the second file to the second information processing system.

### CROSS-REFERENCE TO RELATED APPLICATIONS

This application is based on and claims priority under 35 USC 119 from Japanese Patent Application No. 2016-147185 filed Jul. 27, 2016.

### BACKGROUND

### Technical Field

The present invention relates to a cooperation management apparatus and a communication system.

### SUMMARY

According to an aspect of the invention, a cooperation management apparatus includes:

a key storage unit that stores
a first decryption key corresponding to a first encryption key commonly used by plural information processing systems including first and second information processing systems, and
plural second encryption keys corresponding to second decryption keys individually used by the plural information processing systems;

an acquisition unit that acquires, from the first information processing system, a first file which is encrypted using the first encryption key and which is addressed to the second information processing system;

a decryption unit that decrypts the first file into a second file using the first decryption key;

an encryption unit that encrypts the second file using the second encryption key corresponding to the second decryption key used in the second information processing system; and

an output unit that outputs a third file obtained by encrypting the second file to the second information processing system.

### BRIEF DESCRIPTION OF THE DRAWINGS

Exemplary embodiments of the present invention will be described in detail based on the following figures, wherein:

FIG. 1 is a view illustrating an overall configuration of a communication system according to an exemplary embodiment of the present invention;

FIG. 2 is a block diagram illustrating a configuration of a cooperation management apparatus according to the exemplary embodiment;

FIG. 3 is a view illustrating a configuration of a folder management table according to the exemplary embodiment;

FIG. 4 is a view illustrating a configuration of a key management table according to the exemplary embodiment;

FIG. 5 is a block diagram illustrating a configuration of a server device according to the exemplary embodiment;

FIG. 6 is an explanatory view of keys used in an information processing system according to the exemplary embodiment;

FIG. 7 is a view illustrating a functional configuration of the communication system according to the exemplary embodiment;

FIG. 8 is an explanatory view of an example of a processing executed by the communication system according to the exemplary embodiment; and

FIG. 9 is a view illustrating a functional configuration of a communication system according to a modification of the present invention.

### DETAILED DESCRIPTION

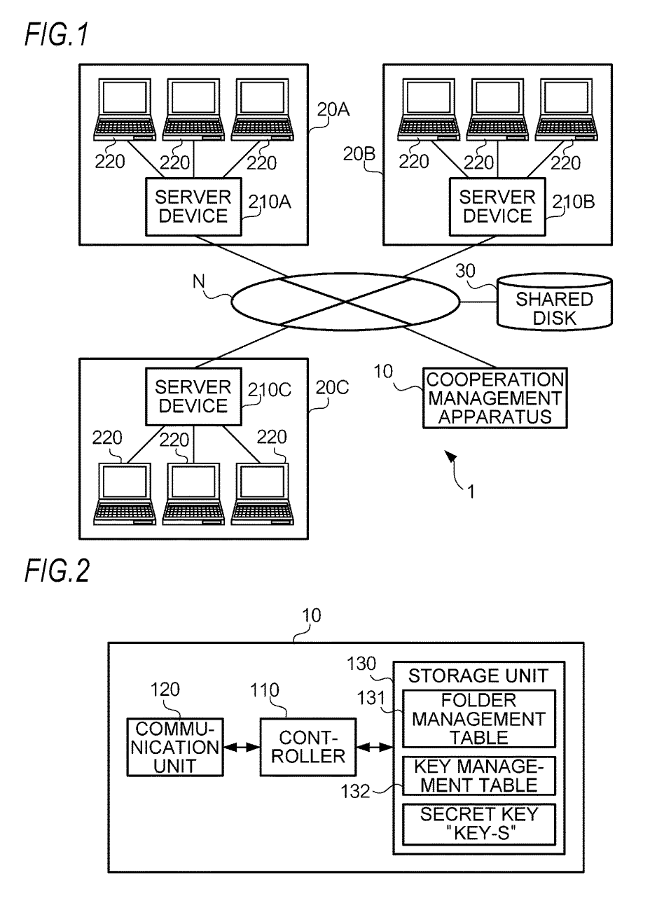

FIG. 1 is a view illustrating an overall configuration of a communication system 1 according to an exemplary embodiment of the present invention. The communication system 1 includes a cooperation management apparatus 10, and plural information processing systems 20. In FIG. 1, as cooperating information processing systems 20, three information processing systems 20A, 20B, and 20C are illustrated. Meanwhile, the number of the information processing systems 20 is not limited to three but may be, for example, two or four or more.

The cooperation management apparatus 10 and each of the plural information processing systems 20 are connected to a communication line N. The communication line N includes, for example, a communication network such as the Internet or a wireless communication network. However, the type of the communication line N is not limited thereto. A shared disk 30 is connected to the communication line N. The shared disk 30 is a storage device accessible by the cooperation management apparatus 10 and each of the plural information processing systems 20 (at least, a server device 210). The shared disk 30 is, for example, a hard disk device, but may be another type of storage device. The shared disk 30 is a storage device used for, for example, a cloud storage service.

The cooperation management apparatus 10 manages file exchanges performed among the plural information processing systems 20. The file exchange is performed by writing and reading a file on/from the shared disk 30. In the file exchange, encryption and decryption of a file are performed. Here, the encryption method is a public key encryption method.

The information processing system 20 is a system in which a processing using a file is executed. The file indicates, for example, a document, but may indicate a file other than the document. The information processing includes, for example, processing such as creation, editing, saving, and the like of a file, but may include other processing. Each of the information processing systems 20A, 20B, and 20C is a server client system that includes the server device 210, and plural client devices 220. When server devices included in the information processing systems 20A, 20B, and 20C are distinguished from each other, the server devices will be referred to as server devices 210A, 210B, and 210C.

FIG. 2 is a block diagram illustrating a hardware configuration of the cooperation management apparatus 10. The cooperation management apparatus 10 includes a controller 110, a communication unit 120, and a storage unit 130. The controller 110 controls respective units of the cooperation management apparatus 10. The controller 110 includes a processor such as a central processing unit (CPU), and a memory. The processor writes and reads data on/from the memory, thereby performing various controls. The communication unit 120 is connected to the communication line N to perform a communication via the communication line N. The communication unit 120 includes, for example, a modem. The storage unit 130 stores data. The storage unit 130 stores, for example, a folder management table 131, a key management table 132, and a secret key “KEY-S.” The storage unit 130 includes, for example, a hard disk device, but may include another type of storage device.

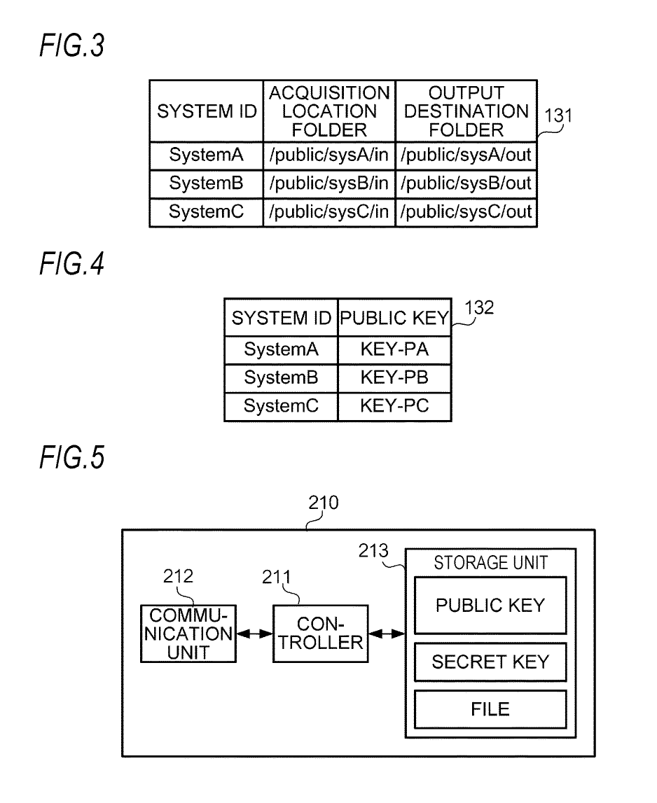

FIG. 3 is a view illustrating a configuration of the folder management table 131. The folder management table 131 is a table used for managing a storage area of the shared disk 30 which is allocated to each information processing system 20. Specifically, the folder management table 131 is a table in which data “system ID,” “acquisition location folder,” and “output destination folder” are associated with each other.

The system ID is an identifier used for identifying the information processing system 20. The system IDs “SystemA,” “SystemB,” and “SystemC,” are identifiers of the information processing systems 20A, 20B, and 20C, respectively. The acquisition location folder is a folder allocated to each information processing system 20, and indicates a folder from which a file to be acquired from the information processing system 20 is acquired. The output destination folder is a folder allocated to each information processing system 20, and indicates a folder that becomes an output destination of a file addressed to the information processing system 20. In the folder management table 131, paths of the acquisition location folder and the output destination folder are stored.

FIG. 4 is a view illustrating a configuration of the key management table 132. The key management table 132 is a table used for managing an encryption key used for encryption of a file addressed to each information processing system 20, for the information processing system 20.

The key management table 132 is a table in which data “system ID” and “public key” are associated with each other. Files addressed to the information processing systems 20A, 20B, and 20C are encrypted using public keys “KEY-PA,” “KEY-PB,” and “KEY-PC,” respectively.

FIG. 5 is a block diagram illustrating a hardware configuration of the server device 210 of the information processing system 20. The server device 210 includes a controller 211, a communication unit 212, and a storage unit 213. The controller 211 includes a processor such as a CPU, and a memory. The processor writes and reads data on/from the memory, thereby performing various controls. The communication unit 212 is connected to the communication line N to perform a communication via the communication line N. The communication unit 212 includes, for example, a modem. The storage unit 213 stores data. The storage unit 213 stores a secret key, a public key, and a file used for a processing. The storage unit 213 includes, for example, a hard disk device, but may include another type of storage device.

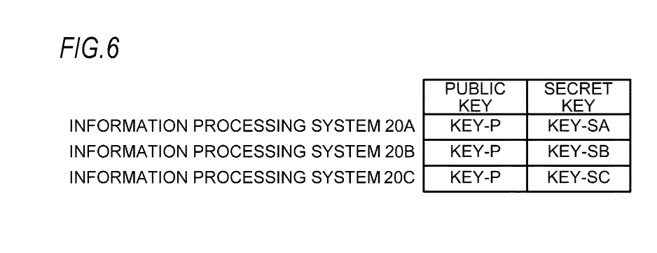

FIG. 6 is a view illustrating the secret key, and the public key stored in each information processing system 20. The storage unit 213 of each of the information processing systems 20A, 20B, and 20C stores a public key “KEY-P” commonly used by the information processing systems 20A, 20B, and 20C. The public key “KEY-P” corresponds to the secret key “KEY-S” stored in the cooperation management apparatus 10. The public key “KEY-P” is an example of a first encryption key of the exemplary embodiment, and the secret key “KEY-S” is an example of a first decryption key of the exemplary embodiment.

The storage units 213 of the information processing systems 20A, 20B, and 20C store secret keys “KEY-SA,” “KEY-SB,” and “KEY-SC,” respectively, as secret keys used individually by the information processing systems 20A, 20B, and 20C. The secret key “KEY-SA” corresponds to the public key “KEY-PA.” The secret key “KEY-SB” corresponds to the public key “KEY-PB.” The secret key “KEY-SC” corresponds to the public key “KEY-PC.” The public keys “KEY-PA,” “KEY-PB,” and “KEY-PC” are examples of second encryption keys of the exemplary embodiment. The secret keys “KEY-SA,” “KEY-SB,” and “KEY-SC” are examples of second decryption keys of the exemplary embodiment.

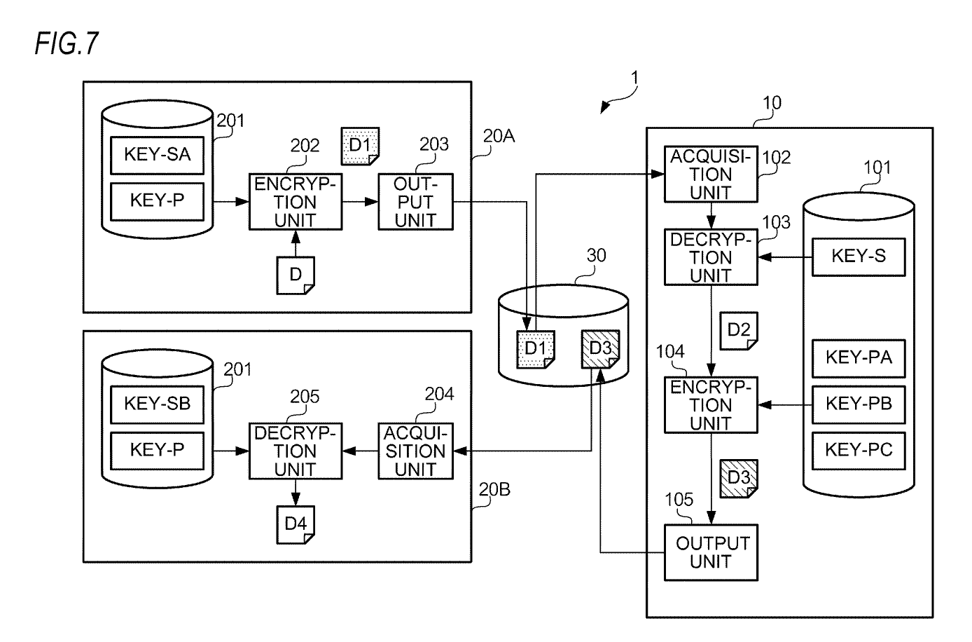

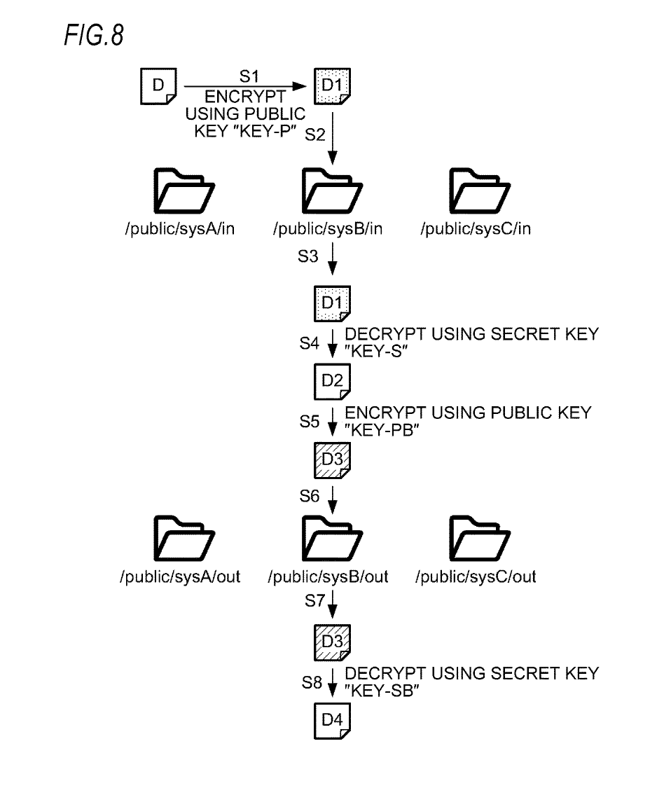

FIG. 7 is a block diagram illustrating a functional configuration of the communication system 1. Functional configurations of the plural information processing systems 20 are same. Meanwhile, FIG. 7 illustrates only a function according to a file exchange in which a file is output from the information processing system 20A to the information processing system 20B. For example, the function of the information processing system 20A is implemented by the server device 210A, and the function of the information processing system 20B is implemented by the server device 210B. The information processing system 20A is an example of a first information processing system of the exemplary embodiment, and the information processing system 20B is an example of a second information processing system of the exemplary embodiment. FIG. 8 is a view illustrating an example of a processing executed by the communication system 1.

The information processing system 20A has functions corresponding to a key storage unit 201, an encryption unit 202, and an output unit 203.

The key storage unit 201 stores the secret key “KEY-SA” and the public key “KEY-P.” The key storage unit 201 is implemented by, for example, the storage unit 213.

The encryption unit 202 encrypts a file to be output to the information processing system 20B using the public key “KEY-P” stored in the key storage unit 201 (step S1 in FIG. 8). Here, it is assumed that a file D is encrypted, and a file D1 is generated. The encryption unit 202 is implemented by, for example, the controller 211. The file D1 is a first file of the exemplary embodiment.

The output unit 203 outputs the encrypted file D1 to the information processing system 20B. Specifically, the output unit 203 stores the file D1 in a storage area allocated to the information processing system 20B, in the storage area of the shared disk 30. Here, the output unit 203 stores the file D1 in the acquisition location folder “/public/sysB/in” associated with the system ID “SystemB” in the folder management table 131 (step S2 in FIG. 8). The output unit 203 is implemented by, for example, the controller 211 and the communication unit 212.

The cooperation management apparatus 10 has functions corresponding to a key storage unit 101, an acquisition unit 102, a decryption unit 103, an encryption unit 104, and an output unit 105. The key storage unit 101 stores the secret key “KEY-S,” and the public keys “KEY-PA,” “KEY-PB,” and “KEY-PC.” The key storage unit 101 is implemented by, for example, the storage unit 130.

The acquisition unit 102 acquires the file D1 addressed to the information processing system 20B, from the information processing system 20A. Specifically, the acquisition unit 102 monitors the storage area of the shared disk 30. This monitoring is performed periodically, for example, at predetermined time intervals. When a file is stored in any one of acquisition location folders specified in the folder management table 131, the acquisition unit 102 acquires the file. Here, the acquisition unit 102 acquires the file D1 from the acquisition location folder “/public/sysB/in” (step S3 in FIG. 8). The acquisition unit 102 is implemented by, for example, the controller 110 and the communication unit 120.

The decryption unit 103 decrypts the file acquired by the acquisition unit 102. Here, the decryption unit 103 decrypts the file D1 into a file D2 using the secret key “KEY-S” (step S4 in FIG. 8). The file D2 is an example of a second file of the exemplary embodiment. The file acquired by the acquisition unit 102 has been encrypted using the public key “KEY-P” commonly used by the plural information processing systems 20. Thus, the decryption unit 103 performs decryption using the secret key “KEY-S,” instead of the information processing system 20 that has stored the file in the acquisition location folder. The decryption unit 103 is implemented by, for example, the controller 110.

The encryption unit 104 encrypts the file decrypted by the decryption unit 103, again. The encryption unit 104 encrypts the file D2 in such a manner that the file D2 can be decrypted by the information processing system 20B. Specifically, the encryption unit 104 selects a key used for the encryption based on the acquisition location folder in which the file D1 is stored. As described for FIG. 3, in the folder management table 131, the acquisition location folder “/public/sysB/in” is associated with the system ID “SystemB.” In the key management table 132, the system ID “SystemB” is associated with the public key “KEY-PB.” Accordingly, the encryption unit 104 encrypts the file D2 using the public key “KEY-PB” to generate a file D3 (step S5 in FIG. 8). The file D3 is an example of a third file of the exemplary embodiment.

The output unit 105 outputs the encrypted file D3 to the information processing system 20B. Specifically, the output unit 105 stores the file D3 in the storage area allocated to the information processing system 20B. The output unit 105 determines which one of the information processing systems 20, an output is addressed to, based on the acquisition location folder in which the file is stored. The output unit 105 stores the file D3 in the output destination folder “/public/sysB/out” associated with the system ID “SystemB” in the folder management table 131 (step S6 in FIG. 8). The output unit 105 is implemented by, for example, the controller 110 and the communication unit 120.

The information processing system 20B has functions corresponding to a key storage unit 201, an acquisition unit 204, and a decryption unit 205. The key storage unit 201 stores the secret key “KEY-SB” and the public key “KEY-P.”

The acquisition unit 204 acquires the output file D3 addressed to the information processing system 20B. Specifically, the acquisition unit 204 monitors a storage area allocated to the information processing system 20B, in the storage area of the shared disk 30. This monitoring is performed periodically, for example, at predetermined time intervals. When a file is stored in an output destination folder associated with the information processing system 20B, the acquisition unit 204 acquires the file. Here, the acquisition unit 204 acquires the file D3 stored in the output destination folder “/public/sysB/out” (step S7 in FIG. 8). The acquisition unit 204 is implemented by, for example, the controller 211 and the communication unit 212.

The decryption unit 205 decrypts the file acquired by the acquisition unit 204 using the secret key “KEY-SB” stored in the key storage unit 201. Here, the decryption unit 205 decrypts the file D3 into a file D4 (step S8 in FIG. 8). The file D4 is an example of a fourth file of the exemplary embodiment. The file D3 has been encrypted by the public key “KEY-PB” corresponding to the secret key “KEY-SB,” and thus can be decrypted in the decryption unit 205. The decryption unit 205 is implemented by, for example, the controller 211. The file D4 is a file having substantially the same contents as the file D.

Descriptions have been made on a file exchange when a file is output from the information processing system 20A to the information processing system 20B. A file exchange made by another combination of the information processing systems 20A, 20B, and 20C is also performed in the procedure as described above. In this case, although a key to be handled and a folder in which a file is to be stored are different from those in the above description, the rest are substantially the same.

Even when plural information processing systems 20 are present, each information processing system 20 may have at least one public key for encrypting a file to be output to another information processing system 20, and one secret key for decrypting a file from another information processing system 20. That is, each information processing system 20 does not have to include an encryption key corresponding to a decryption key included in a cooperation-destination information processing system 20, and a decryption key corresponding to an encryption key included in the cooperation-destination information processing system 20. Thus, when encrypted files are exchanged among the plural information processing systems 20, it is not necessary for each information processing system 20 to include a key for each cooperating opponent.

The present invention may be implemented in a form different from the above described exemplary embodiment. Modifications described below may be combined.

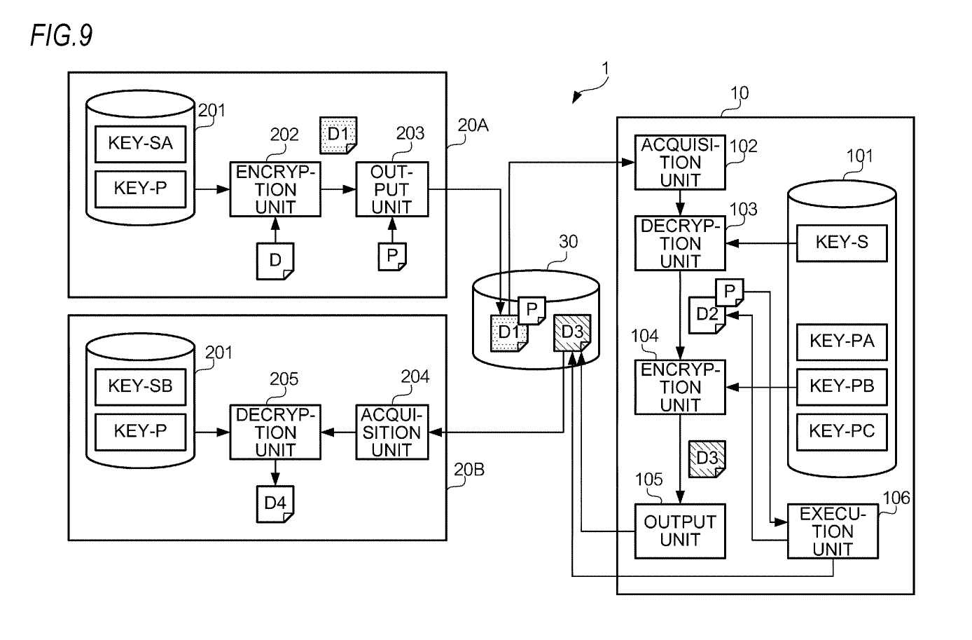

FIG. 9 is a view illustrating a functional configuration of a communication system 1 according to the modification. The modification is different from the above described exemplary embodiment in that a file is associated with a policy file P. The policy file P is an example of data that instructs execution of a processing based on the associated file. Examples of the processing may include designation of file output destination, conversion of a file format, a time limit until which file output is permitted (release time limit), and the like. The processing is designated by, for example, the server device 210 or the client device 220.

The output unit 203 of the information processing system 20A associates the file D1 with the policy file P, and outputs the file D1 and the policy file P to the information processing system 20B. When the file D1 and the policy file P are stored in the shared disk 30, the acquisition unit 102 of the cooperation management apparatus 10 acquires the file D1 and the policy file P. When the file D1 is decrypted into a file D2 by the decryption unit 103, an execution unit 106 executes the instructed processing based on the policy file P.

For example, it is assumed that an information processing system 20 as an output destination of the file is specified in the policy file P. In this case, the execution unit 106 instructs the output unit 105 to store the file D2 in an output destination folder corresponding to the output destination. It is assumed that a conversion of a file format of the file D2 is instructed in the policy file P. In this case, the execution unit 106 converts the file format according to the instruction. It is assumed that a time limit until which file output is permitted is specified in the policy file P. In this case, the execution unit 106 disables the output of a file D3 passing the time limit to the information processing system 20. For example, the execution unit 106 deletes the file D3 from the shared disk 30.

According to the communication system 1 of the modification, a processing designated by the information processing system 20 may be executed according to the data associated with the file.

The hardware configuration or functional configuration of the cooperation management apparatus 10 or the server device 210 is not limited to the configuration described above for the exemplary embodiment.

A part of the configuration or operation of the communication system 1 described above for the exemplary embodiment may be omitted. For example, an output destination of the file may be selected by a method other than the selection of the acquisition location folder or the output destination folder. For example, when the output destination is specified using the policy file P, a processing related to the file exchange may proceed without separating the acquisition location folder and the output destination folder for each information processing system 20. A file encryption method is not limited to the public encryption method, but other encryption methods may be employed.

The information processing system 20 may not be a server client system. For example, the information processing system may be implemented by a single computer apparatus (information processing apparatus).

Respective functions implemented by the controller 110 or the controller 211 according to the above described exemplary embodiment may be implemented by one or more hardware circuits, one or more programs executed by a computing device, or a combination thereof. When the functions of the controller 110 or the controller 211 are implemented by a program, the program may be provided while being recorded in a computer readable recording medium such as a magnetic recording medium (a magnetic tape, a magnetic disk (e.g., a hard disk drive (HDD), a flexible disk (FD))), an optical recording medium (e.g., an optical disc), a magneto-optical recording medium, and a semiconductor memory, or may be distributed via a network. The exemplary embodiment may be considered as a cooperation management method performed by a computer.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A cooperation management apparatus comprising:
a key storage unit that stores
a first decryption key corresponding to a first encryption key commonly used by a plurality of information processing systems including first and second information processing systems, and
a plurality of second encryption keys corresponding to second decryption keys individually used by the plurality of information processing systems;
an acquisition unit that acquires, from the first information processing system, a first file which is encrypted using the first encryption key and which is addressed to the second information processing system;
a decryption unit that decrypts the first file into a second file using the first decryption key;
an encryption unit that encrypts the second file using the second encryption key corresponding to the second decryption key used in the second information processing system; and
an output unit that outputs a third file obtained by encrypting the second file to the second information processing system.

2. The cooperation management apparatus according to claim 1, wherein
a storage device is accessible by the plurality of information processing systems,
a storage device has storage areas allocated to the plurality of information processing systems, respectively,
the acquisition unit acquires the first file from the storage area of the storage device which is allocated to the second information processing system,
the encryption unit encrypts the second file using the second encryption key which is selected based on the storage area in which the first file is stored, and
the output unit stores the third file in the storage area allocated to the second information processing system.

3. The cooperation management apparatus according to claim 1, wherein
the acquisition unit acquires data which instructs execution of processing in association with the first file,
the cooperation management apparatus further comprising:
an execution unit that executes the processing instructed by the data, based on the second file or the third file.

4. The cooperation management apparatus according to claim 2, wherein
the acquisition unit acquires data which instructs execution of processing in association with the first file,
the cooperation management apparatus further comprising:
an execution unit that executes the processing instructed by the data, based on the second file or the third file.

5. A communication system comprising:
a plurality of information processing systems; and
the cooperation management apparatus according to claim 1, wherein
each of the plurality of information processing systems includes
a key storage unit that stores the first encryption key and the second decryption key,
an output unit that outputs the first file encrypted using the first encryption key to the second information processing system,
an acquisition unit that acquires the third file which is output to the own information processing system by the cooperation management apparatus, and
a decryption unit that decrypts the third file into a fourth file using the second decryption key.

6. A communication system comprising:
a plurality of information processing systems; and
the cooperation management apparatus according to claim 2, wherein
each of the plurality of information processing systems includes
a key storage unit that stores the first encryption key and the second decryption key,
an output unit that outputs the first file encrypted using the first encryption key to the second information processing system,
an acquisition unit that acquires the third file which is output to the own information processing system by the cooperation management apparatus, and
a decryption unit that decrypts the third file into a fourth file using the second decryption key.

7. A communication system comprising:
a plurality of information processing systems; and
the cooperation management apparatus according to claim 3, wherein
each of the plurality of information processing systems includes
a key storage unit that stores the first encryption key and the second decryption key,
an output unit that outputs the first file encrypted using the first encryption key to the second information processing system,
an acquisition unit that acquires the third file which is output to the own information processing system by the cooperation management apparatus, and
a decryption unit that decrypts the third file into a fourth file using the second decryption key.

8. A communication system comprising:
a plurality of information processing systems; and
the cooperation management apparatus according to claim 4, wherein
each of the plurality of information processing systems includes
a key storage unit that stores the first encryption key and the second decryption key,
an output unit that outputs the first file encrypted using the first encryption key to the second information processing system,
an acquisition unit that acquires the third file which is output to the own information processing system by the cooperation management apparatus, and
a decryption unit that decrypts the third file into a fourth file using the second decryption key.
